(19) United States
(12) Patent Application Publication
(10) Pub. No.: US 2005/0009726 A1
(43) Pub. Date: Jan. 13, 2005

(54) Stain treating composition

(76) Inventors: Giorgio Franzolin, Mirano (IT); Anthony Dominick Sidoti, Padova (IT); Luca Spadoni, Mirano (IT)

Correspondence Address: Norris McLaughlin & Marcus, 30th Floor, 220 East 42nd Street, New York, NY, 10017, US

(21) Appl. No.: 10/490,237

(22) PCT Filed: Jul. 18, 2003
(86) PCT No.: PCT/GB03/03137

(30) Foreign Application Priority Data
Jul. 20, 2002 (GB) 0216950.6
Apr. 10, 2003 (GB) 0308231.0

(51) Int. Cl. C11D 1/00

(52) U.S. Cl. 510/477

(57) ABSTRACT

A two-compartment dispenser comprising a first compartment containing an aqueous composition comprising a source of active oxygen and a second compartment containing an aqueous composition comprising an alkalising agent.

This invention relates to an improved process for the removal of stains from surfaces, preferably from fabric, and to compositions used in such processes.

The use of oxygen bleaches with or without enzymes in compositions for stain removal has been known for a long time and many such compositions are available. However a common difficulty in formulating such a composition is to ensure that the bleach remains stable during storage but is sufficiently active on use. This is particularly difficult to achieve in liquid compositions.

One solution has been to formulate liquid peroxygen bleaches at pHs between about 3 and 7 to produce a stable composition, but such compositions do not provide sufficient bleaching power to be useful for many household situations. Attempts have therefore also been made to formulate liquid peroxygen bleach compositions at pHs above this range to improve their performance. However these generally require expensive stabilising compounds to prevent loss of activity after manufacture.

The present invention provides a peroxide or peracid bleach product which has acceptable stability of the peroxide or peracid during storage, but which is capable of providing effective stain removal power when used by the consumer.

WO 9731095 describes an apparatus for claiming surfaces that contains two liquids that are mixed upon delivery to the surface. The first liquid contains a hydrohalite bleach. The second liquid has a chelating agent or a builder. The pH on mixture of the two liquids is about 11.

We have found that providing two separate compositions that are mixed during, before or after (preferably during or before) application have excellent stability and performance.

Enzymes are a common component of stain treating compositions. Enzymes lose their cleaning performance in presence of a strong oxidant, such as hydrogen peroxide at alkaline pH. Surprisingly, we have found that by the inclusion of a surfactant or a water-soluble polymer in either or both of the separate compositions, (preferably present in at least the enzyme composition or both compositions) excellent cleaning performance is achieved. Whilst not wishing to be bound by theory, it is believed that the activity of the enzyme is maintained for a longer period after the peroxide composition is mixed with the enzyme composition by the protective effects of surfactant micelles formed in the mixture.

According to the invention there is provided a process for stain removal at a surface, comprising applying to that surface an aqueous composition comprising a source of active oxygen, preferably of hydrogen peroxide or a source thereof, which composition has a pH of 7 or more and comprises a mixture of:
(a) an aqueous composition comprising a source of active oxygen having a pH of greater than 0 but less than 7 [hereinafter component (a)] and
(b) an aqueous composition [hereinafter component (b)] comprising an alkalising agent.

Preferably component(a) and/or component (b) additionally comprise at least one surfactant or water-soluble polymer and are mixed not more than two hours before being applied to the surface requiring stain removal.

Preferably component (b) also contains at least one enzyme.

Sources of Active Oxygen

An essential ingredient is a source of active oxygen. A preferred source according to the present invention is hydrogen peroxide or sources thereof. As used herein a hydrogen peroxide source refers to any water-soluble sources of hydrogen peroxide. Suitable water-soluble sources of hydrogen peroxide for use herein include percarbonates, organic or inorganic peroxides and perborates.

Ideally, the pH of component (a) is less than 5, ideally less than 4, preferably less than 3. Preferably the pH of component (a) is greater than 1, greater than 2 or greater than 2.5.

Hydrogen peroxide or sources thereof provide from 0.1% to 15%, preferably from 0.5% to 10%, most preferably from 1% to 5% by weight of the total composition of active oxygen in component (a).

As used herein active oxygen concentration refers to the percentage concentration of elemental oxygen, with an oxidation number zero, that being reduced to water would be stoichiometrically equivalent to a given percentage concentration of a given peroxide compound, when the peroxide functionality of the peroxide compound is completely reduced to oxides. The active oxygen sources according to the present invention increase the ability of the compositions to remove oxidisable stains, to destroy malodourous molecules and to kill germs.

The concentration of available oxygen can be determined by methods known in the art, such as the iodimetric method, the permanganometric method and the cerimetric method. Said methods and the criteria for the choice of the appropriate method are described for example in “Hydrogen Peroxide”, W. C. Schumo, C. N. Satterfield and R. L. Wentworth, Reinhold Publishing Corporation, New York, 1955 and “Organic Peroxides”, Daniel Swern, Editor Wiley Int. Science, 1970.

Suitable organic and inorganic peroxides for use in the compositions according to the present invention include diacyl and dialkyl peroxides such as dibenzoyl peroxide, dilauroyl peroxide, dicumyl peroxide, persulphuric acid and mixtures thereof. The component (a) according to the present invention comprise from 0% to 15%, preferably from 0.005% to 10%, by weight of the total composition of said organic or inorganic peroxides.

Suitable preformed peroxyacids for use in the compositions according to the present invention include diperoxydodecandioic acid DPDA, magnesium perphthalatic acid, perlauric acid, perbenzoic acid, diperoxyazelaic acid and mixtures thereof. The compositions according to the present invention comprise from 0% to 15%, preferably from 0.005% to 10%, by weight of the total composition of said preformed peroxyacids.

Optionally, component (a) or component (b) or both components (a) and (b) may additionally comprise from 0% to 30%, preferably from 2% to 20%, by weight of peracid precursors, i.e. compounds that upon reaction with hydrogen peroxide product peroxyacids. Examples of peracid precursors suitable for use in the present invention can be found among the classes of anhydrides, amides, imides and esters such as acetyl triethyl citrate(ATC) described for instance in EP 91 87 0207, tetra acetyl ethylene diamine(TAED), succinic or maleic anhydrides.

pH

The pH of component (a) is preferably less than 7, ideally less than 6.5, 6,0, 5.5, 5.0, 4.5, 4.0, 3.5 or 3.0. Ideally the pH is at least 1.0, 1.5, 2.0 or 2.5.

The pH of component (b) is preferably greater than 7, ideally greater than 7.5, 8.0, 8.5, 9.0, 9.5 or 10.0. Ideally the pH is less than 13.0, 12.5, 12.0 or 11.5.

The pH of either (a) or (b) can be adjusted by the addition of a suitable acid or base.

Alkalising Agent

As an essential element the compositions according to the present invention comprise an alkalising agent. The alkalising agent must be sufficient to raise the pH of the [a] and [b] mixture to pH of greater than 8, ideally greater than 9, 10, 11 or 12. Ideally the pH is raised up to 14, 13 or 12. Suitable alkalising agents are caustic alkalis such as sodium hydroxide, potassium hydroxide and/or lithium hydroxide and/or the alkali metal oxides such as sodium and/or potassium oxide. A preferred source of alkalinity is a caustic alkali, more preferably sodium hydroxide and/or potassium hydroxide.

Ideally, an alkaline buffering means is also present. An alkaline buffering means at a level of from 0.1% to 10% by weight of component (b). Preferably, component (b) herein comprise from 0.2% to 8% by weight of the total composition of a pH buffering means or a mixture thereof, preferably from 0.3% to 5%, more preferably from 0.3% to 3% and most preferably from 0.3% to 2%.

By “alkaline buffering means”, it is meant herein any compound which when mixed with component (a) makes the resulting solution able to resist an increase in hydrogen ion concentration.

Preferred alkaline buffering means for use herein comprise an acid having its pK (if only one) or at least one of its pKs in the range from 7.5 to 12.5, preferably from 8 to 10, and its conjugated base.

pK is defined according to the following equation:
pK=−log K
where K is the Dissocation Constant of the weak acid in water and corresponds to the following equation:
[A][H]/[HA]=K
where HA is the acid and A is the conjugated base.

Preferably the alkaline buffering means herein consists of the weak acid as defined herein and its conjugate base at a weight ratio of the weak acid to its conjugate base of preferably 0.1:1 to 10:1, more preferably 0.2:1 to 5:1. Highly preferred ratio of the weak acid to its conjugate base is 1 since this is the best combination to achieve optimum buffering capacity.

Preferably a given pH buffering means herein will be used to buffer compositions having a pH between pH=pK−1 and pH=pK+1 of each of its pK.

Effervescence

In one preferred embodiment of the invention an effervescent effect is achieved upon mixing (a) and (b). The effervescent agent containing component preferably comprises a base, preferably present at a level of from about 1% to about 10%, more preferably from about 2% to about 5% by weight of the compositions of the present invention. Preferably the effervescent agent is in component (b).

Suitable bases for use in the effervescent agent-containing component are selected from carbonates, bicarbonates, sesquicarbonates and mixtures thereof. Preferably, the base is selected from the group consisting of sodium carbonate, potassium carbonate, lithium carbonate, magnesium carbonate, calcium carbonate, ammonium carbonate, mono-, di-, tri-or tetra-alkyl or aryl, substituted or unsubstituted, ammonium carbonate, sodium bicarbonate, potassium bicarbonate, lithium bicarbonate, magnesium bicarbonate, calcium bicarbonate, ammonium bicarbonate, mono-, di-, tri-or tetra-alkyl or aryl, substituted or unsubstituted, ammonium bicarbonate and mixtures thereof.

The most preferred bases are selected from the group consisting of sodium bicarbonate, monoethanol-ammonium bicarbonate and mixtures thereof.

In another preferred embodiment, the effervescent agent preferably comprises a peroxide reducing enzyme that is held within component (b) [and (a) containing hydrogen peroxide], such as peroxidase, laccase, dioxygenase and/or catalase enzyme, preferably catalase enzyme, preferably present at a level of from about 0.001% to about 10%, more preferably, from about 0.01% to about 5%, even more preferably from about 0.1% to about 1%, most preferably from about 0.1% to about 0.3% by weight of the compositions of the present invention. Catalase enzyme is commercially available from Biozyme Laboratories under the trade name Cat-1A, which is a bovine liver derived catalyse enzyme; from Genencor International under the trade name Oxy-Gone 400, which is a bacterial derived catalyse enzyme; and from Novo Nordisk under the trade name Terminox Ultra 50L.

Quick Breaking Foam

The effervescence system linked with the presence of surfactant is likely to produce foam upon mixing component (a) with component (b). However, it is not always desirable that the foam is one that is stable since this may mean that the foam is difficult to rinse away or obscures from the user the cleaning effect of the compositions.

Therefore, as a further feature of the invention the surfactant is selected from those that are capable of producing breaking foams. Preferably the foam breaks within 5 minutes of generation after application to the surface, ideally less than 5, 4, 3, 2, or 1 minute. Preferably the foam does not break for at least 10, 20 or 30 seconds or 1, 2 or 3 minutes. By the use of the term “break or breaks” we mean that at least 50% of the volume of foam generated by the mixing of component (a) and (b) has disappeared without any form of physical or chemical intervention.

Preferred surfactants to produce capable of performing a break are:

Anionic Surfactant

Preferred anionic surfactants capable of producing a breaking foam are ethoxylated alkyl sulfates of the formula:
RO(C₂H₄O)ₙSO₃⁻M⁺
wherein R is a C₈-C₂₀ alkyl group, preferably C₁₀-C₁₈ such as a C₁₂-C₁₆, n is at least 4, for example from 4 to 20, preferably 4 to 9, especially 4 to 6, and M is a salt-forming cation such as lithium, sodium, potassium, ammonium, alkylammonium or alkanolammonium.
   Nonionic Surfactants

Preferred nonionic surfactants capable of producing a breaking foam are fatty alcohol ethoxylates, especially those of formula:
R(C₂H₄O)ₙOH
wherein R is a straight or branched C₈-C₁₆ alkyl group, preferably a C₉-C₁₅, for example C₁₀-C₁₄, alkyl group and n is at least 4, for example from 4 to 16, preferably 4 to 12, more preferably 4 to 10.

Preferably the HLB value is greater than 9, ideally greater than 10.

The ethoxylated fatty alcohol nonionic surfactant will frequently have a hydrophilic-lipophilic balance (HLB) which ranges from 3 to 17, more preferably from 6 to 15, most preferably from 10 to 15.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company.

An additional or alternative group of preferred nonionic surfactants are the polyoxyalkylated non-ionics of formula:
R¹O[CH₂CH(R³)O]ₓ[CH₂]ₖCH(OH)[CH₂]ⱼOR²
wherein R¹ and R² represent linear or branched chain, saturated or unsaturated, aliphatic or aromatic hydrocarbon groups with 1-30 carbon atoms (presently 1 to 10) or one of R¹ and R² may be a hydrogen, R³ represents a hydrogen atom or a methyl group, x is a value between 2 and 30 and, k and j are values between 1 and 12, preferably between 1 and 5. R¹ and R² are preferably linear or branched chain, saturated or unsaturated, aliphatic or aromatic hydrocarbon groups with 6-22 carbon atoms, where group with 8 to 18 carbon atoms are particularly preferred. Particularly preferred values for x are comprised between 2 and 20, preferably between 4 and 15.

When x=2 or 3, the group R³ could be chosen to build ethylene oxide (R³=H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 2 or 3 for x is only an example and bigger values can be chosen whereby a higher number of variations of (EO) or (PO) units would arise.

Alternatively when x=2 or 3, the group R³ could be chosen to build ethylene oxide (R³=H) or propylene oxide (R³=methyl) units which can be used in every single order for instance (EO)(EO)(EO), (PO)(PO)(PO), (PO)(EO)(PO), (EO)(PO)(EO), (PO)(PO) and (EO)(EO). The value 2 or 3 for x is only an example and bigger values can be chosen .whereby a higher number of variations of (EO) or (PO) units would arise.

Particularly preferred polyoxyalkylated alcohols of the above formula are those where k=1 and j=1 originating molecules of simplified formula:

R¹O[CH₂CH(R³)O]ₓCH₂CH(OH)CH₂OR². A suitable example is Biodac 232, available from Condea or Berol 185 from Akzo Nobel.

Enzyme

Where present said enzymes are preferably selected from cellulases, hemicellulases, peroxidases, proteases, gluco-amylases, amylases, xylanases, lipases, phospholipases, esterases, cutinases, pectinases, keratanases, reductases, oxidases, phenoloxidases, lipoxygenases, ligninases, pullulanases, tannases, pentosanases, malanases, beta-glucanases, arabinosidases, hyaluronidase, chondroitinase, laccase or mixtures thereof.

Preferred enzymes include protease, amylase, lipase, peroxidases, cutinase and/or cellulase.

The cellulases usable in the present invention include both bacterial or fungal cellulase. Preferably, they will have a pH optimum of between 5 and 12 and an activity above 50 CEVU (Cellulose Viscosity Unit). Suitable cellulases are disclosed in U.S. Pat. No. 4,435,307, JP-A-61078384 and WO-A-96/02653 which disclose fungal cellulases produced respectively from Humicola insolens, Trichoderma, Thielavia and Sporotrichum. EP-A-739 982 describes cellulases isolated from novel Bacillus species. Suitable cellulases are also disclosed in GB-A-2.075.028; GB-A-2.095.275; DE-OS-2.247.832 and WO-A-95/26398.

If present, cellulases are normally incorporated in the detergent composition at levels from 0.0001% to 2% of active enzyme by weight of the detergent composition.

Peroxidase enzymes are used in combination with oxygen sources, e.g. percarbonate, perborate, persulfate, hydrogen peroxide, etc. They are used for “solution bleaching”, i.e. to prevent transfer of dyes or pigments removed from substrates during wash operations to other substrates in the wash solution. Peroxidase enzymes are known in the art, and include, for example, horseradish peroxidase, ligninase and haloperoxidase such as chloro- and bromo-peroxidase. Peroxidase-containing detergent compositions are disclosed, for example, in WO-A-89/099813, WO-A-89/09813 and in EP-A-540784. Also suitable is the laccase enzyme.

If present, peroxidases are normally incorporated in the detergent composition at levels from 0.0001% to 2% of active enzyme by weight of the detergent composition.

Other preferred enzymes that can be included in the detergent compositions of the present invention include lipases. Suitable lipase enzymes for detergent usage include those produced by microorganisms of the Pseudomonas group, such as Pseudomonas stutzeri ATCC 19.154, as disclosed in GB-A-1,372,034. Suitable lipases include those which show a positive immunological cross-reaction with the antibody of the lipase, produced by the microorganism Pseudomonas fluorescent IAM 1057. This lipase is available from Amano Pharmaceutical Co. Ltd., Nagoya, Japan, under the trade name Lipase P “Amano,” hereinafter referred to as “Amano-P”. Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands, and lipases ex Pseudomonas gladioli. Especially suitable lipases are lipases such as M1 Lipase™ and Lipomax™ (Gist-Brocades) and Lipolase™ and Lipolase Ultra™ (Novo) which have found to be very effective when used in combination with the compositions of the present invention. Also suitables are the lipolytic enzymes described in EP-A-258068, WO-A-92/05249, WO-A-95/22615, WO-A-94/03578, WO-A-95/35381 and WO-A-96/00292.

Also suitable are cutinases [EC 3.1.1.50] which can be considered as a special kind of lipase, namely lipases which do not require interfacial activation. Addition of cutinases to detergent compositions have been described in e.g. WO-A-88/09367; WO-A-90/09446, WO-A-94/14963 and WO-A-94/14964.

The lipases and/or cutinases are normally incorporated in either or both composition at a level from 0.0001% to 2% of active enzyme by weight of the composition.

Suitable proteases are the subtilisins which are obtained from particular strains of B. subtilis and B. licheniformis (subtilisin BPN and BPN′). One suitable protease is obtained from a strain of Bacillus, having maximum activity throughout the pH range of 8-12, developed and sold as ESPERASE™ by Novo Industries A/S of Denmark, hereinafter “Novo”. The preparation of this enzyme and analogous enzymes is described in GB-A-1,243,784 to Novo. Other suitable proteases include ALCALASE™, DURAZYM™ and SAVINASE™ from Novo and MAXATASE™, MAXACAL™, PROPERASE™ and MAXAPEM™ (protein engineered Maxacal) from Gist-Brocades. Proteolytic enzymes also encompass modified bacterial serine proteases, such as those described in EP-A-292623 (particularly pages 17, 24 and 98), and which is called herein “Protease B”, and in EP-A-199,404, which refers to a modified bacterial serine protealytic enzyme which is called “Protease A” herein. Suitable is what is called herein “Protease C”, which is a variant of an alkaline serine protease from Bacillus in which lysine replaced arginine at position 27, tyrosine replaced valine at position 104, serine replaced asparagine at position 123, and alanine replaced threonine at position 274. Protease C is described in WO-A-91/06637. Genetically modified variants, particularly of Protease C, are also included herein.

High pH protease are preferred, such as from Bacillus sp. NCIMB 40338 described in WO-A-93/18140. Enzymatic detergents comprising protease, one or more other enzymes, and a reversible protease inhibitor are described in WO-A-92/03529. When desired, a protease having decreased adsorption and increased hydrolysis is available as described in WO-A-95/07791. A recombinant trypsin-like protease for detergents suitable herein is described in WO-A-94/25583. Other suitable proteases are described in EP-A-516,200.

The proteolytic enzymes are incorporated in either or both compositions at a level of from 0.0001% to 2%, preferably from 0.001% to 0.2%, more preferably from 0.005% to 0.1% pure enzyme by weight of the composition.

Amylases (alpha and/or beta) can be included for removal of carbohydrate-based stains. WO-A-94/02597 describes cleaning compositions which incorporate mutant amylases. See also WO-A-95/10603. Other amylases known for use in cleaning compositions include both alpha- and beta-amylases. alpha-Amylases are known in the art and include those disclosed in U.S. Pat. No. 5,003,257; EP-A-252,666; WO-A-/91/00353; FR-A-2,676,456; EP-A-285,123; EP-A-525,610; EP-A-368,341; and GB-A-1,296,839. Other suitable amylases are stability-enhanced amylases described in WO-A-94/18314 and WO-A-96/05295 and amylase variants having additional modification in the immediate parent available from Novo Nordisk A/S, disclosed in WO-A-95/10603. Also suitable are amylases described in EP-A-277,216, WO-A-95/26397 and WO-A-96/23873.

Examples of commercial alpha-amylases products are Purafect Ox Am™ from Genencor and Termamyl™, Ban™, Fungamyl™ and Duramyl™, Natalase™ all available from Novo Nordisk A/S Denmark. WO-A-95/26397 describes other suitable amylases: alpha-amylases characterised by having a specific activity at least 25% higher than the specific activity of Termamyl™ at a temperature range of 25 DEG C. to 55 DEG C. and at a pH value in the range of 8 to 10, measured by the Phadebas™ alpha-amylase activity assay. Suitable are variants of the above enzymes, described in WO-A-96/23873. Other amylolytic enzymes with improved properties with respect to the activity level and the combination of thermostability and a higher activity level are described in WO-A-95/35382.

Preferred amylase enzymes include those described in WO-A-95/26397 and in co-pending application by Novo Nordisk PCT/DK96/00056.

The amylolytic enzymes are incorporated in either or both compositions at a level of from 0.0001% to 2%, preferably from 0.00018% to 0.06%, more preferably from 0.00024% to 0.048% pure enzyme by weight of the composition

Surfactant

Preferably, the total levels of surfactant are at levels of 0.1 to 25% wt, ideally from 1 to 10% wt.

Ideally, sufficient surfactant is present in each composition (a) and (b) such that upon mixture of (a) and (b) the critical micelle concentration (CMC) is reached, i.e. the level above which formation of micelles occurs [typically measured by a change in physical properties, i.e. turbidity or conductivity],

Preferably non-ionic surfactants are used. Examples of non-ionic surfactants are fatty acid alkoxylates, such as fatty acid ethoxylates, especially those of formula:
R(C₂H₄O)ₙOH
wherein R is a straight or branched C₈-C₁₆ alkyl group, preferably a C₉-C₁₅, for example C₁₀-C₁₄, alkyl group and n is at least 1, for example from 1 to 16, preferably 2 to 12, more preferably 3 to 10.

The alkoxylated fatty alcohol non-ionic surfactant will frequently have a hydrophilic-lipophilic balance (HLB) which ranges from 3 to 17, more preferably from 6 to 15, most preferably from 7 to 13.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂-C₁₃ alcohol having about 9 moles of ethylene oxide; and Neodol 91-10, an ethoxylated C₉-C₁₁ primary alcohol having about 10 moles of ethylene oxide.

Alcohol ethoxylates of this type have also been marketed by Shell Chemical Company under the Dobanol trademark. Dobanol 91-5 is an ethoxylated C₉-C₁₁ fatty alcohol with an average of 5 moles ethylene oxide and Dobanol 25-7 is an ethoxylated C₁₂-C₁₅ fatty alcohol with an average of 7 moles of ethylene oxide per mole of fatty alcohol.

Other examples of suitable ethoxylated alcohol non-ionic surfactants include Tergitol 15-S-7 and Tergitol 15-S-9, both of which are linear secondary alcohol ethoxylates available from Union Carbide Corporation. Tergitol 15-S-7 is a mixed ethoxylated product of a C₁₁-C₁₅ linear secondary alkanol with 7 moles of ethylene oxide and Tergitol 15-S-9 is the same but with 9 moles of ethylene oxide.

Other suitable alcohol ethoxylated non-ionic surfactants are Neodol 45-11, which is a similar ethylene oxide condensation products of a fatty alcohol having 14-15 carbon atoms and the number of ethylene oxide groups per mole being about 11. Such products are also available from Shell Chemical Company.

Further non-ionic surfactants are, for example, C₁₀-C₁₈ alkyl polyglycosides, such s C₁₂-C₁₆ alkyl polyglycosides, especially the polyglucosides. These are especially useful when high foaming compositions are desired. Further surfactants are polyhydroxy fatty acid amides, such as C₁₀-C₁₈ N-(3-methoxypropyl) glycamides and ethylene oxide-propylene oxide block polymers of the Pluronic type.

The surfactant can also be an anionic surfactant. Such anionic surface active agents are frequently provided in a salt form, such as alkali metal salts, ammonium salts, amine salts, aminoalcohol salts or magnesium salts. Contemplated as useful are one or more sulfate or sulfonate compounds including: alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Particularly preferred are alkyl sulfate anionic surfactants. Most preferred are the non-ethoxylated C₁₂-₁₅ primary and secondary alkyl sulfates, especially sodium lauryl sulfate.

In a further feature of the invention a surfactant is chosen to be present in either (a), (b) or both (a) and (b) that is capable of forming a stable foam. Such systems are described in EP0745665.

Polymer

Suitable polymers are those that are water-soluble and include polycarboxylate polymer (such as those that can be purchased by Rohm and Haas under the Acusol 445N name) and polycarboxylic acid copolymers (such as can be purchased under the Sokalan CP9 name by BASF)

Compositions suitable for carrying out the invention may be provided as separate components suitable for mixing by the consumer. Where the compositions are suitable for mixing they may be mixed either directly at the surface or remote from the surface before application.

Component (a) preferably comprises hydrogen peroxide or peracetic acid.

In accordance with the invention the two components (a) and (b) may be mixed in any suitable proportions, depending upon their initial concentrations, suitably such that the finally applied mixture comprises 0.01-30%, by weight of hydrogen peroxide or an organic peracid. Preferably, the ratio of component (a) to component (b) is from 10:1 to 1:10, most preferably from 2:1 to 1:2.

When component (a) and (b) are mixed it is preferred that the pH of the mixture is greater than 7, ideally greater than 8, 9, 10, 11 or 12.

It is preferred that the two components (a) and (b) are mixed no more than 10 minutes before application to the surface requiring stain removal.

It is most preferred that the two components (a) and (b) are mixed at the surface requiring stain removal, so that the improved stain removal effect may occur immediately.

In this aspect component (a) may be applied to the surface followed by component (b) or vice versa. Alternatively (and preferably) components (a) and (b) are applied to the surface substantially simultaneously within 30 seconds.

According to a preferred embodiment of the presentation invention, the concentration of hydrogen peroxide or organic peracid in the composition immediately after mixing is from 0.01 to 10% w/w. This would mean for example in a 1:1 mix of component (a) and (b) that component (a) prior to the mixing would contain from 0.02 to 20% w/w of hydrogen peroxide or an organic peracid.

Where component (a) comprises hydrogen peroxide it is most preferred that the concentration of hydrogen peroxide in the mixture immediately after mixing should be from 1.5 to 5% w/w. For example, if a 1:1 mixture of components (a) and (b) is to be mixed, then component (a) should comprise from 3 to 10% w/w hydrogen peroxide.

The concentration of the enzyme in component (b) will be less than 1% wt.

The process of the present invention alleviates the need to use further stabilising components for the hydrogen peroxide/organic peracid or enzyme when preparing commercial products.

The components suitable for use in the process according to the invention may further include any other conventional additives known to the art. Examples of these include fragrances, dyes, sequesterants, chelating agents, germicides, preservatives, corrosion inhibitors or antioxidants.

The above auxiliary components may be included in the compositions suitable for use in the process of the present invention at concentrations of from 0.01% w/w to 10% w/w. These auxiliary ingredients may be included in either component (a), or component (b) or both if appropriate.

Compositions suitable for use in the process according to the present invention may be stored in any appropriate containers known to the art. For example, the two components may be stored in two-compartment packs suitable for sequential or simultaneous dispensing.

Where both components (a) and (b) are liquids, most preferably they may be stored in a two-compartment dispenser, one compartment containing each component and the dispenser being adapted to dispense each component on to a surface, either sequentially or, preferably, simultaneously.

According to a further aspect of the invention, there is provided a two-compartment dispenser comprising
a first compartment containing an aqueous composition comprising hydrogen peroxide or an organic peracid and having a pH of greater than 0 but less than 7:
a second compartment containing an aqueous composition comprising an alkalising agent and;
dispensing means adapted to dispense the contents (or part thereof) of the compartments on to a surface either sequentially or simultaneously to form a mixture thereof.

Preferably wherein the first compartment and/or the second compartment additionally comprise at least one surfactant or water-soluble polymer.

Preferably, the first compartment contains an aqueous composition comprising 3 to 10% w/w hydrogen peroxide; and the second compartment contains an aqueous composition comprising less than 1% w/w of an enzyme.

The invention will now be illustrated by the following Examples.

### EXAMPLE 1

| Compartment 1 | % wt |
|---|---|
| Hydrogen Peroxide | 7.3 |
| Oxo Alcohol C12-C15 5EO | 7.0 |
| HEDP | 0.12 |
| Water | up to 100 |
| pH (100%) | 3.8 |

| Compartment 2 | % |
|---|---|
| Sodium Bicarbonate | 10.0 |
| Water | up to 100 |
| PH | 8.5 |

### EXAMPLE 2

| First chamber | % wt |
|---|---|
| Water | 71.8 |
| Hydrogen peroxide 50% | 14 |
| Citric Acid 50% | 10 |
| Chelating Agent | 1 |
| Sodium hydroxide 50% | 3.2 |
| Total | 100.0 |

| Second chamber | % wt |
|---|---|
| Water | 73.58 |
| Dowicil 75 | 0.050 |
| Sodium borate decahydrate | 0.514 |
| Trisodium citrate | 1.3 |
| Copolymer dispersant(25%) | 0.200 |
| Enzyme | 0.44 |
| Sodium bicarbonate | 4 |
| Propylene glycol | 4 |
| Berol 185 | 15 |
| Acusol | 0.7 |
| Perfume | 0.21 |
| Total | 100 |

### EXAMPLE 3

| First chamber | % wt |
|---|---|
| Water | 71.8 |
| Hydrogen peroxide 50% | 14 |
| Citric Acid 50% | 10 |
| Chelating agent 40% | 1 |
| Sodium hydroxide 50% | 3 |
| Total | 100 |

| Second chamber | % wt |
|---|---|
| Water | 70.586 |
| Dowicil 75 | 0.05 |
| Sodium borate decahydrate | 0.514 |
| Trisodium citrate | 1.3 |
| Copolymer dispersant (25%) | 0.2 |
| Enzyme | 0.44 |
| Sodium bicarbonate | 4 |
| Propylene glycol | 4 |
| Nonionic surfactant | 18 |
| Acusol polymer(45%) | 0.7 |
| Perfume | 0.21 |
| Total | 100 |

### EXAMPLE 4

| First chamber | % wt |
|---|---|
| Water | 61.1985 |
| Hydrogen peroxide 50% | 14 |
| Propylene glycol | 2 |
| Nonionic surfactant | 9 |
| Citric Acid 50% | 10 |
| Chelating agent 40% | 1 |
| Colour pigment | 0.0015 |
| Sodium hydroxide 50% | 2.8 |
| Total | 100 |

| Second chamber | % wt |
|---|---|
| Water | 81.586 |
| Dowicil 75 | 0.05 |
| Sodium borate decahydrate | 0.514 |
| Trisodium citrate | 1.3 |
| Copolymer dispersant (25%) | 0.2 |
| Enzyme | 0.44 |
| Sodium bicarbonate | 4 |
| Propylene glycol | 2 |
| Nonionic surfactant | 9 |
| Acusol polymer (45%) | 0.7 |
| Perfume | 0.21 |

### EXAMPLE 5

| First chamber | % wt |
|---|---|
| Water | 71. 8 |
| Hydrogen peroxide 50% tech | 14 |
| Citric Acid 50% | 10 |
| Pentasodium DTPA 40% | 1 |
| Sodium hydroxide 50% | 3.2 |
| Total | 100 |

| Second chamber | % wt |
|---|---|
| Water | 73.586 |
| Dowicil 75 | 0.05 |
| Sodium borate decahydrate | 0.514 |
| Trisodium citrate | 1.3 |
| Dispersant Polymer (25%) | 0.2 |
| Enzyme | 0.44 |
| Sodium bicarbonate | 4 |
| Propylene glycol | 4 |
| Berol 185 | 15 |
| Acusol (45%) | 0.7 |
| Perfume | 0.21 |
| Total | 100 |

Conditions of test 1 ml of product was placed on the soil, scrubbed five times by hand and left to react for 5 minutes. The materials were then washed in a US top loading washing-machine (Whirlpool Imperial) on the cycle for medium load at 30C temp with water of 12 F hardness and a 1.5/1 Ca/Mg ratio. The materials were evaluated by measuring the reflectance (Y value) using a Ultrascan XE Spectrophotometer.

1. A process for stain removal at a surface, comprising applying to that surface an aqueous composition, which composition has a pH of 7 or more and comprises a mixture of:
component (a): an aqueous composition comprising a source of active oxygen and having a pH of greater than 0 but less than 7 and
component (b): an aqueous composition comprising an alkalising agent.

2. A process according to claim 1 wherein components (a) or (b) additionally comprise at least one surfactant or water-soluble polymer.

3. A process according to claim 2 wherein component (b) additionally comprises at least one enzyme.

4. A process according to claim 2 wherein the surfactant is a non-ionic surfactant.

5. A process according to claim 4 wherein component (a) or component (b) additionally contains a polycarboxylate.

6. A process according to claim 1 wherein the pH of component (b) is greater than 9.

7. A process according to claim 1 wherein component (b) contains a pH buffer.

8. A process according to claim 1 wherein component (b) additionally comprises an effervescent agent.

9. A process according to claim 8 wherein the effervescent agent is a base or is a peroxide reducing enzyme.

10. A process according to claim 9 wherein the base is a carbonate or a bicarbonate.

11. A process according to claim 2 wherein the surfactant produces a foam upon mixing components (a) and (b).

12. A process according to claim 11 wherein the foam breaks.

13. A process according to claim 11 wherein the foam reduces in volume by at least 50% in less than 5 minutes of its generation without any form of physical or chemical intervention.

14. A process according to claim 2 wherein surfactant is a nonionic surfactant having an HLB of greater than 10.

15. A two-compartment dispenser comprising a first compartment containing an aqueous composition comprising a source of active oxygen and having a pH of greater than 0 but less than 7;
a second compartment containing an aqueous composition comprising an alkalising agent; and
dispensing means adapted to dispense the contents (or part thereof) of the compartments on to a surface either sequentially or simultaneously to form a mixture thereof.
